(19) United States
(12) Patent Application Publication
(10) Pub. No.: US 2020/0122031 A1
(43) Pub. Date: Apr. 23, 2020

(54) Remote Networked Services for Providing Contextual Information

(71) Applicant: Sony Interactive Entertainment LLC, San Mateo, CA (US)

(72) Inventors: Adil Sherwani, Oakland, CA (US); Steven Patrick Trombetta, San Francisco, CA (US); Charles Wayne Denison, II, Piedmont, CA (US); Matthew Stewart Bloom-Carlin, San Francisco, CA (US); Derek Andrew Parker, San Francisco, CA (US); Benedikt Neuenfeldt, Tokyo (JP); Yohei Nishikawa, Tokyo (JP); Tsuyoshi Ono, Tokyo (JP); Junya Noda, Tokyo (JP)

(21) Appl. No.: 16/653,641

(22) Filed: Oct. 15, 2019

Related U.S. Application Data
(60) Provisional application No. 62/748,974, filed on Oct. 22, 2018.

(51) Int. Cl. A63F 13/35; A63F 13/795; A63F 13/798; A63F 13/87

(52) U.S. Cl. CPC A63F 13/35; A63F 13/87; A63F 13/798; A63F 13/795

(57) ABSTRACT

Systems and methods for providing contextual information regarding available game activities are provided herein. An example method includes maintaining a list of activities associated with at least one application; receiving information associated with an availability of an activity to a user; determining an estimated playtime for an available activity; and generating a user interface having contextual information associated with one or more of the available activities, the contextual information including the estimated playtime.

### CROSS REFERENCE TO RELATED APPLICATIONS

This application claims the benefit of U.S. Provisional Application No. 62/748,974, filed on Oct. 22, 2018.

### FIELD

The present technology relates generally to remote networked game services, and more particularly to providing users with contextual information regarding available game activities.

### BACKGROUND

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

Video games are getting more complex, while the time allotted to play them is more limited than ever. Players want to stay engaged and immersed in the video games that they play, from start to finish. However, these players often have questions about the game that they are playing, and to get answers to these questions, they have to leave the game and engage with third party sites. This is because in-game states and video game activities are not aggregated and analyzed across video games and video game players. It would be a colossal amount of work for a game developer to implement all the features necessary to provide the player help with the game and to reduce player frustration within the context of a single game. Therefore, a data model and developer-friendly API is needed to support multiple players and gaming environments across a uniform data platform.

Moreover, players can get overwhelmed with the many available activities that modern games (including open-world games and closed-world games) offer in the flow of a game (“game flow”). Due to the large number of options provided in such games, much of a player's scarce console time is spent choosing what to do next in the game. In the worst case scenario, choice paralysis can cause player churn, in which a player stops playing the game. Additionally, players can often turn down an opportunity to play games if they have limited playtime available (e.g., less than two hours) as they may not have confidence that they can complete a meaningful in-game activity in that available playtime.

For example, players struggle to predict how long it will take to get back into a narrative-rich game. Those players may wait until they have a larger available amount of time to play, but such time slots may be few and far between. In the meantime, players lose focus of where in the narrative they were, what activities they were in the middle of, etc., which further exacerbates the difficulty to get back into the game. This problem is compounded by the multiplicity of other forms of entertainment that have fixed durations or only require a player to have a short attention span.

Thus, there is a long-felt need for a system that allows players to plan ahead and choose their in-game activity before beginning to play, by reviewing available activities with key contextual information, such as playtime estimates and refresher information, needed to make a selection before playing.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Generally, the present disclosure refers to a remote networked service for providing users with contextual information regarding available game activities. The remote networked service may be referred herein as “game plan,” which allows users to review, at a platform level (on and off console), at least one game activity available to them across the game or games that the user is actively playing. The platform provides contextual information regarding a game activity, such as estimated playtime, in-game location, and rewards. The user may then make an informed selection regarding the game activity before launching the game, and thus focuses time on gameplay rather than navigating menus to look at options.

The remote networked services provide guidance on the next available in-game activity. The activities may include time-sensitive activities, quest-based activities, or achievement-based activities, for example. Each activity is a discrete portion of a game having associated metadata, the metadata for each activity including a name, a description, an image, a date range (for time-limited activities, for example), and other information as described herein. On a per-user basis, the associated metadata may include whether the activity is available (based on progression, for example), whether the activity should be hidden to avoid spoilers, and an estimated playtime. In one or more embodiments, activities are instantiated as activity instances, which have associated metadata including a start time, an end time, a player roster, context information (difficulty, loadout, map, etc.), outcome information (score, completion time, etc.), and a progress amount.

In various embodiments, the remote networked service has access to a uniform data system that provides a methodology for game clients and game servers to send data to the platform without requiring per-feature or per-service integration. The remote networked service has access to contextual information related to a game application for a user, including: any progression and activities, including names, descriptions, and statuses associated with an activity, and telemetry regarding start and end timestamps for an activity, estimated playtime, in-game location, and rewards; any actions and outcomes, including an initiator, a timestamp, and a location associated with an action and an impacted entity, a timestamp, a location, and a related action associated with an outcome; any zones and locations, including names, descriptions, virtual coordinates, and events associated with a zone and location; any characters and attributes, including character statistics, inventory, abilities, and telemetry regarding changes to character statistics, inventory, and abilities; any choices and branches, including dialog, path, options for a branching situation, and telemetry regarding a user encountering a particular branch and which option was selected.

The contextual information may include information associated with the availability of an activity to a user. The information may itself provide whether an activity is available to a user. The information may also allow the server to make a determination whether an activity is available to a user.

In various embodiments, unified activity modules represent relevant available activities that the user may engage with. For example, a unified activity module may represent a single-player level or quest that is available or in progress, a multiplayer mode, an active multiplayer match, a trophy, or other available in-game event. A unified activity module includes a description, a location, an estimated duration of time (i.e. estimated playtime), rewards for completing the activity, a progress indicator or any combination thereof. The estimated duration of time may be an approximation of how long the particular activity will take the user to complete. The estimated duration of time may be based on statistical information from the completion time of other users, completion time of the user for other activities, user self-identification of skill and thoroughness, etc. The unified activity module may also include a suggestion as to whether the user should start the activity now or wait until achieving a higher readiness later, based at least in part upon an estimated success rate.

The user interface may present a plurality of unified activity modules, organized by progress, location, rewards, or time remaining (for activities with a set available time window). The particular unified activity modules presented to a user may be based on contextual information, such as proximity to a virtual location of the user's character, amount of progression towards completing the activity, friend completion or availability status on the activity (including the friend's outcome on the activity such as a score, completion time, character(s) used, difficulty setting, etc.), friend challenges, an estimated playtime, a duration in which the activity is available, or other suitable information.

According to another aspect of embodiments disclosed herein, a user interface provides users with information regarding in-progress activities. The information may be tied in with a codex to show the user media associated with the game or activities in the game plan to provide the user a recap to resume after a break.

In certain embodiments, in response to user selection of an activity via the user interface, the remote networked service transmits a boot parameter to the client to launch the application with the selected activity. The boot parameter is configured to launch the application and navigate to the available activity. The boot parameter may be transmitted to the same client or a different client configured to execute the associated application.

The user interface may be presented via a number of client devices, such as a personal computer (PC), tablet PC, game console, gaming device, set-top box (STB), television device, cellular telephone, portable music player (e.g., a portable hard drive audio device), web appliance, or any machine capable of presenting the user interface.

### BRIEF DESCRIPTION OF THE DRAWINGS

Embodiments are illustrated by way of example, and not by limitation in the figures of the accompanying drawings, in which like references indicate similar elements.

FIG. 1 shows an exemplary system architecture for providing users with contextual information regarding available game activities, according to one example embodiment.

FIG. 2 illustrates another exemplary system architecture, according to one example embodiment.

FIG. 3 shows an exemplary system for providing a data model for a uniform data platform, according to one example embodiment.

FIG. 4 depicts an exemplary user interface, according to one example embodiment.

FIG. 5 shows another exemplary user interface, according to one example embodiment.

FIG. 6 illustrates a flow diagram of a method for providing users with contextual information regarding available game activities.

FIG. 7 is a diagrammatic representation of an example machine in the form of a computer system within which a set of instructions for the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents.

In general, various embodiments of the present disclosure are directed to providing users with contextual information regarding available game activities. The contextual information may include information associated with the availability of an activity to a user. The information may itself provide whether an activity is available to a user. The information may also allow the server to make a determination whether an activity is available to a user.

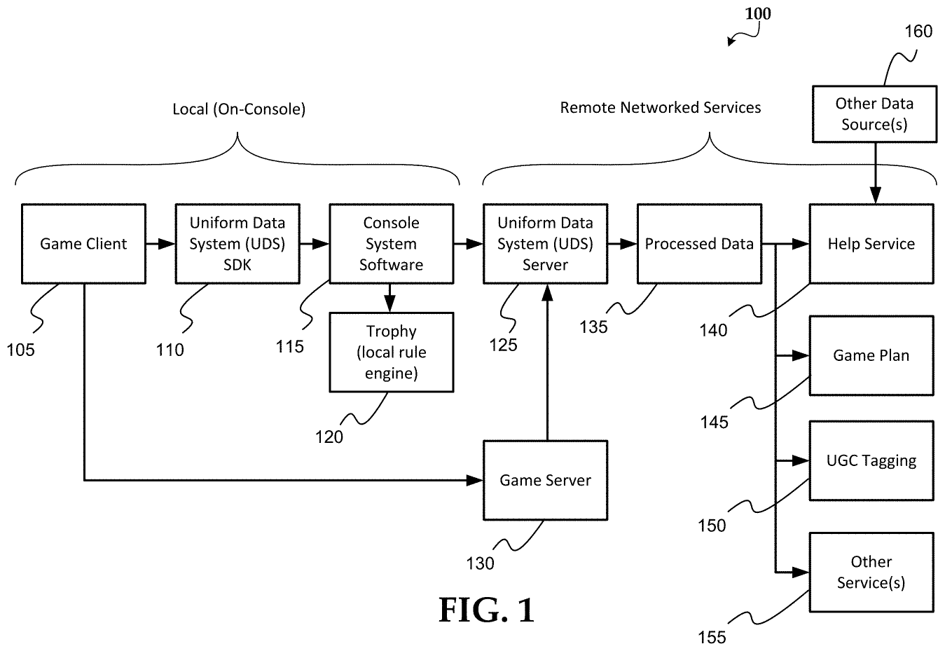

FIG. 1 is an exemplary system architecture 100 for providing users with contextual information regarding available game activities, according to one example embodiment. In some embodiments, the exemplary system architecture 100 includes a game client 105, a uniform data system (UDS) software development kit (SDK) 110, console system software 115, a local rule engine 120, a UDS server 125, a game server 130, processed data 135, and one or more other remote networked services, including a help service 140, game plan 145, user generated content (UGC) tagging 150, and other service(s) 155. The help service 140 may also receive information from other data source(s) 160.

The game client 105 and game server 130 provide contextual information regarding at least one application to a uniform data system (UDS) server 125 via a UDS data model describing the logical structure of UDS data used by the UDS SDK 110. The UDS data model enables the platform to realize remote networked services, such as the help service 140, game plan 145, UGC tagging 150, and other service(s) 155 that require game data, without requiring a game to be patched separately to support a service. The UDS data model assigns contextual information to a portion of information in a unified way across games. The contextual information from the game client 105 and UDS SDK 110 is provided to the UDS server 125 via the console system software 115. It is to be understood that the game client 105, UDS SDK 110, console system software 115, and local rule engine 120 may run on a computer or other suitable hardware for executing at least one application.

The UDS server 125 receives and stores contextual information from the game client 105 and game server 130 from at least one application. To be sure, the UDS server 125 may receive contextual information from a plurality of game clients and game servers for multiple users. The information may be uniformly processed 135 and then received by the plurality of remote networked services 140, 145, 150, and 155.

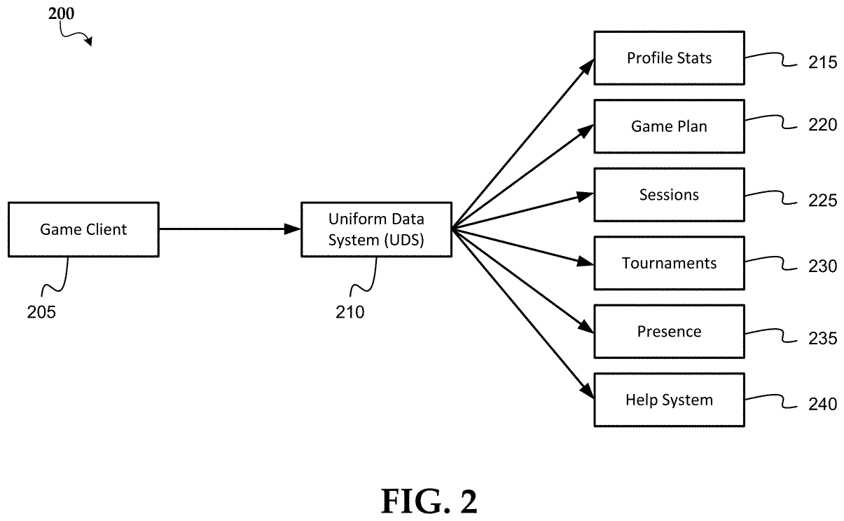

FIG. 2 shows another exemplary embodiment of a system architecture according to the present disclosure. A game client 205 sends contextual information to a UDS server 210, which provides the contextual information in a unified data model to a plurality of remote networked services, including profile stats 215, game plan 220, sessions 225, tournaments 230, presence 235, and help system 240.

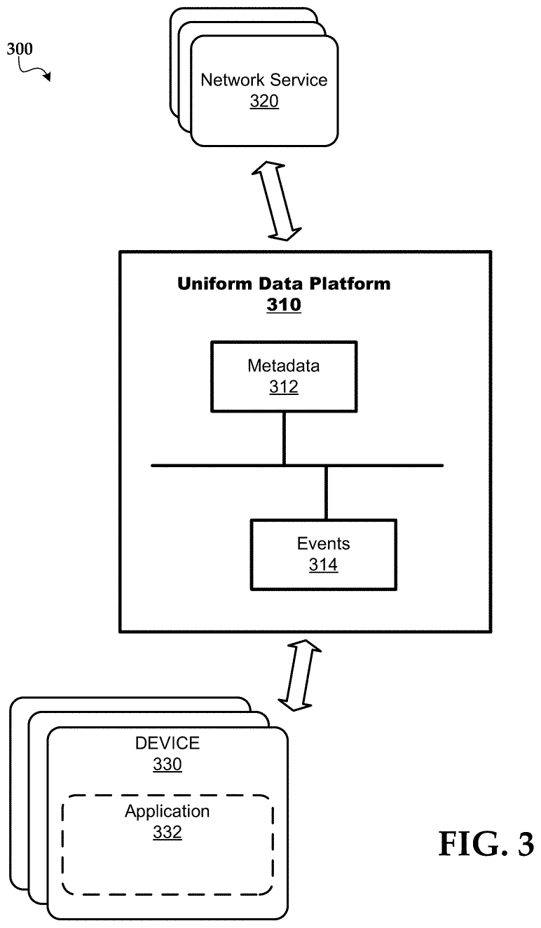

FIG. 3 illustrates an exemplary system for providing data model for a uniform data platform 300, according to an example embodiment of the disclosure. In one example embodiment, system 300 can include at least one device 330 configured to execute at least one of a plurality of applications 332, each application having an application data structure. A uniform data platform 310 can be executed on one or more servers. The uniform data platform 310 can include a data model which is uniform across the plurality of application data structures. The data model can include metadata 312 corresponding to at least one object indicated in the data model, and events 314 corresponding to a trigger condition associated with at least one metadata entry. The values of the metadata 312 and events 314 can be associated with a user profile. The uniform data platform 310 can be configured to receive application data from the at least one device 330 and store the application data within the data model. The system 300 can also include a plurality of remote networked services 320 configured to access the application data from the uniform data platform 310 using the data model.

In various embodiments, the metadata 312 may include: a list of all activities that a user can do in an application, an activity name, a description of the activity, a state of the activity (whether available, started, or completed), whether the activity is required to complete an objective or campaign, a completion reward for the activity, an intro or outro cutscene, an in-game location, one or more conditions that must be met before the activity becomes available, and a parent activity that contains the activity as a sub-activity. Metadata 312 may further include: a list of abilities exercisable by the user, effects of each action, telemetry indicative of when actions and effects take place including corresponding timestamps and locations, an in-game coordinate system, a list of in-game branch situations, and telemetry indicative of when a branch situation is encountered and which option is selected by the user. A list of in-game statistics, items, lore, in-game zones and corresponding attributes regarding each statistic, item, lore, or zone may likewise be included in the metadata 312. In addition, the metadata 312 may indicate whether or not a particular activity, entity (such as a character, item, ability, etc.), setting, outcome, action, effect, location, or attribute should be marked as hidden.

Events 314 may be fired in response to several various trigger conditions. For example, such trigger conditions may include: an activity that was previously unavailable becomes available, a user starts an activity, a user ends an activity, an opening or ending cutscene for an activity begins or ends, the user's in-game location or zone changes, an in-game statistic changes, an item or lore is acquired, an action is performed, an effect occurs, the user interacts with a character, item, or other in-game entity, and an activity, entity, setting, outcome, action, effect, location, or attribute is discovered. The events 314 may include further information regarding a state of the application when the events 314 were triggered, for example a timestamp, a difficulty setting and character statistics at the time a user starts or ends an activity, success or failure of an activity, or a score or duration of time associated with a completed activity. It is to be understood that metadata 312 and events 314 may include any and all contextual information related to activities described in the present disclosure.

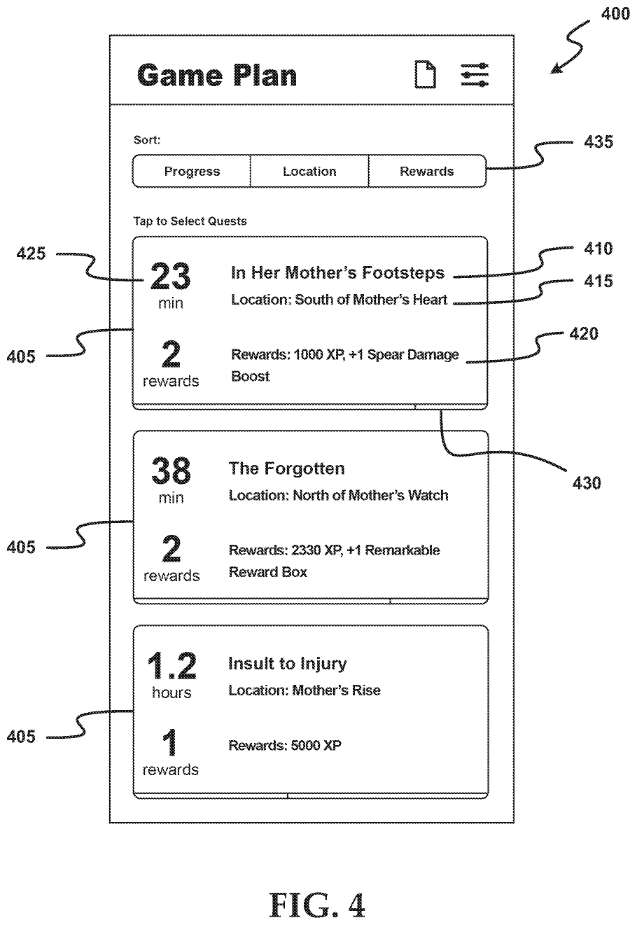

FIG. 4 illustrates an exemplary embodiment of a user interface 400 for a game plan remote networked service of the present disclosure. The user interface 400 includes a plurality of activity modules 405 representing activities available to the user or that are in-progress. The user interface 400 may similarly include activities that are unavailable or completed. An activity module 405 includes a name 410, a location 415, a list of rewards 420, an estimated playtime 425, and a current progress 430. Each activity module 405 presented by the user interface 400 may be updated in real-time, to ensure that the user has the latest available information to decide what to do next. In response to a user selection, such as a tap or click, a verbal query via a speech recognition system, or other suitable user input, the user interface 400 may provide further contextual information regarding the available activity. The further contextual information may include one or more parent activities, one or more sub activities, related media (such as cutscenes, audiologs, in-game books, lore, etc. that have been discovered by the user), and help information to complete the selected activity.

In various embodiments, the user interface 400 is generated based on metadata, such as metadata stored in a UDS server. The metadata may indicate the type and current status of each activity. For example, types of activities include in-game activities, multiplayer sessions, in-game events, user scheduled events, trophies, featured/promoted activities, pinned activities to list on top, or hidden activities to list on bottom. In-game activities may have a status of unavailable, available, in-progress with an amount of user progression, or completed (including the outcome of the activity such as a score, completion time, character(s) used, difficulty setting, etc.). Multiplayer sessions may be joined, not joined, currently active, upcoming, and/or available to join, and in-game events or user scheduled events may be registered, not registered, currently active, upcoming, and/or available to register. Trophies may be locked, unlocked, or in-progress with an amount of user progression towards unlocking the trophy. The metadata associated with a particular activity may further indicate whether the activity is required to complete the core game campaign, which may be predefined by the game developer.

For unavailable activities, the user interface 400 may include recommendations for next available or in-progress activities to complete that will eventually lead to the selected unavailable activity. For example, an activity may only be available if the user has progressed to a particular stage, has completed another activity, acquired a particular item, etc., or any combination thereof. The availability of the activity may be based on a tree list or other suitable progression of activities. In this way, an activity may include one or more parent activities, and one or more sub activities. Consequently, the user interface 400 may include a recommendation to complete one or more parent activities or other requirements in order to gain access to the unavailable activity.

The user interface 400 may further include a sorting input 435, which may cause the system to re-sort the activity modules 405 by a progression (such as a value of the current progress 430), a location (such as location 415 and a virtual distance between the location and the user's current in-game location), or rewards (such as a value of the rewards 420). The activity modules 405 may similarly be sorted by a progression to unlocking a trophy, a type or status of the activity, whether the activity is required or optional for the core game campaign, an estimated playtime, whether the estimated playtime is less than a predetermined or selectable amount of time, a given game title, or whether the user has received a challenge to complete the activity. The user interface 400 may include additional controls to allow the user to search activities, to pin an activity to a pinned activities sub-group that appears near a top of the list of activity modules 405, to hide an activity to a hidden activities sub-group that appears near a bottom of the list of activity modules 405, or to register or unregister from an in-game or user scheduled event. To assist in reorienting a user to an overall game story, the additional controls may further include a control to allow the player to see an automatically generated sequence of previously encountered cutscenes across a game, in chronological order of when they were previously encountered.

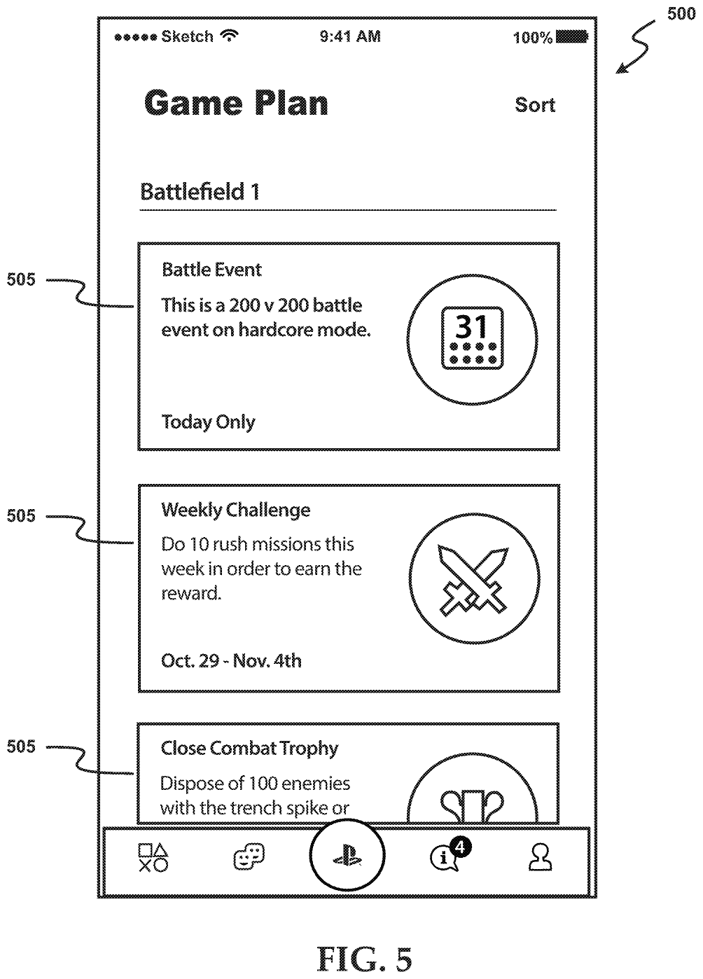

FIG. 5 illustrates another exemplary embodiment of a user interface 500 of the present disclosure. The user interface 500 includes a plurality of activity modules 505 representative of time-sensitive or urgent activities that are about to expire. The activity modules 505 may likewise be sorted by an amount of time remaining for the activity, and display to the user the amount of time remaining.

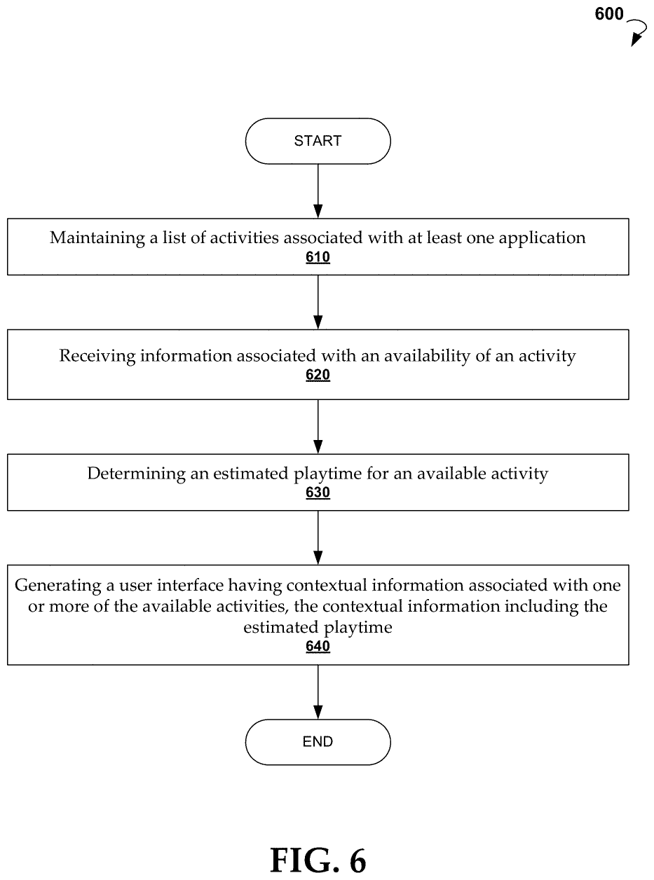

FIG. 6 is a process flow diagram showing a method 600 for providing a game plan remote networked service, according to an example embodiment. Method 600 can be performed by processing logic that includes hardware (e.g., decision-making logic, dedicated logic, programmable logic, application-specific integrated circuit), software (such as software run on a general-purpose computer system or a dedicated machine), or a combination of both. In example embodiments, the processing logic refers to one or more elements of the system architecture 100 and 200 of FIGS. 1 and 2. Operations of method 600 recited below can be implemented in an order different than the order described and shown in the figure. Moreover, method 600 may have additional operations not shown herein, but which can be evident from the disclosure to those skilled in the art. Method 600 may also have fewer operations than shown in FIG. 6 and described below.

Method 600 commences at block 610 with maintaining a list of activities associated with at least one application. For example, the list of activities may include levels, quests, trophies, multiplayer modes, etc. associated with a particular game application. The information is maintained by one or more servers, for example, PlayStation Network® or PSN, or other suitable server. It is to be understood that the one or more servers may likewise maintain other contextual information associated with the at least one application, as described in the present disclosure. The information maintained by the one or more servers may be updated in real time, such that the list of activities, user status information for an activity, and estimated playtimes are up-to-date.

In block 620, the method 600 may include receiving information from a client, the information indicative of whether an activity is available to a user. The information may include whether the activity should be hidden to avoid spoilers, and an estimated playtime. The information received from the client may likewise include information regarding one or more instances of an activity, such as an activity name, a start time, an end time, a player roster, a minimum and maximum number of players, one or more counts or percentages of collectibles acquired, context information (difficulty, loadout, map, etc.), outcome information (score, completion time, etc.), and a progress amount. An activity may be available to the user if one or more conditions are met. For example, an activity may only be available if the user has progressed to a particular stage, has completed another activity, acquired a particular item, etc., or any combination thereof. The availability of the activity may be based on a tree list or other suitable progression of activities. In this way, an activity may include one or more parent activities, and one or more sub activities.

In block 630, the method 600 may include determining an estimated playtime for an available activity. In various embodiments, the determining is based on one or more of a received estimated playtime, statistical information from the completion time of other users, completion time of the user for other activities, user character statistics, user self-identification of skill and thoroughness, a developer-estimated playtime, or other suitable information.

Determining the estimated playtime may also include estimating the user's readiness for the available activity, with respect to in-game statistics, equipment, or skill. The system may determine an expected success rate based on character statistics, equipment, and skill. The estimated playtime may be further based on completion time of other users having a similar readiness to the user, such as using the same character, or having similar in-game statistics, equipment, or skills.

In block 640, the method 600 may include generating a user interface having contextual information associated with one or more of the available activities, the contextual information including the estimated playtime. The user interface may then be presented to the user so that the user may review at a platform level the list of available activities across the at least one application to make an informed selection of how to spend his or her time. The estimated playtime may be presented as a single value or a range of time. It is to be understood that the user interface may be generated by the client device based on up-to-date information received from one or more servers, such as the UDS server 125, or it may be generated on a remote server and transmitted to the client device. Moreover, the client device may include a cache for the contextual information associated with the one or more activities, which may be used if the client device is disconnected or otherwise unable to reach the one or more servers.

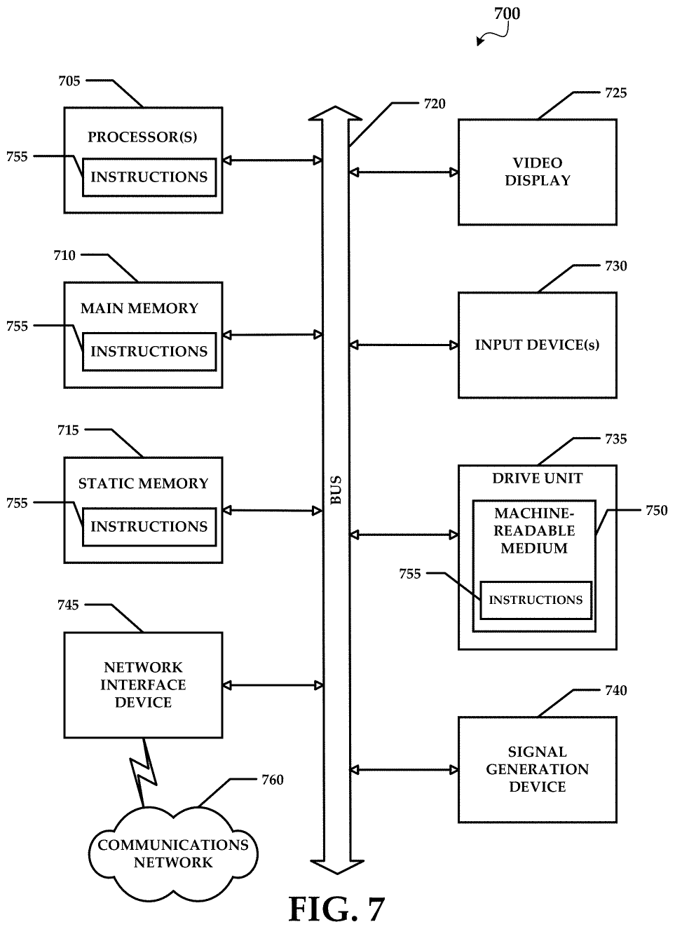

FIG. 7 shows a diagrammatic representation of a computing device for a machine in the example electronic form of a computer system 700, within which a set of instructions for causing the machine to perform any one or more of the methodologies discussed herein can be executed. In example embodiments, the machine operates as a standalone device, or can be connected (e.g., networked) to other machines. In a networked deployment, the machine can operate in the capacity of a server, a client machine in a server-client network environment, or as a peer machine in a peer-to-peer (or distributed) network environment. The machine can be a personal computer (PC), tablet PC, game console, gaming device, set-top box (STB), television device, cellular telephone, portable music player (e.g., a portable hard drive audio device), web appliance, or any machine capable of executing a set of instructions (sequential or otherwise) that specify actions to be taken by that machine. Further, while only a single machine is illustrated, the term “machine” shall also be taken to include any collection of machines that separately or jointly execute a set (or multiple sets) of instructions to perform any one or more of the methodologies discussed herein. Computer system 700 can be an instance of at least a console (see e.g. FIG. 1), game server 130, or UDS server 125, for example.

The example computer system 700 includes a processor or multiple processors 705 (e.g., a central processing unit (CPU), a graphics processing unit (GPU), or both), and a main memory 710 and a static memory 715, which communicate with each other via a bus 720. The computer system 700 can further include a video display unit 725 (e.g., a Liquid-Crystal Display (LCD)). The computer system 700 also includes at least one input device 730, such as an alphanumeric input device (e.g., a keyboard), a cursor control device (e.g., a mouse), a microphone, a digital camera, a video camera, and so forth. The computer system 700 also includes a disk drive unit 735, a signal generation device 740 (e.g., a speaker), and a network interface device 745.

The drive unit 735 (also referred to as the disk drive unit 735) includes a machine-readable medium 750 (also referred to as a computer-readable medium 750), which stores one or more sets of instructions and data structures (e.g., instructions 755) embodying or utilized by any one or more of the methodologies or functions described herein. The instructions 755 can also reside, completely or at least partially, within the main memory 710 and/or within the processor(s) 705 during execution thereof by the computer system 700. The main memory 710 and the processor(s) 705 also constitute machine-readable media.

The instructions 755 can be further transmitted or received over a communications network 760 via the network interface device 745 utilizing any one of a number of well-known transfer protocols (e.g., Hyper Text Transfer Protocol (HTTP), CAN, Serial, and Modbus). The communications network 760 includes the Internet, local intranet, Personal Area Network (PAN), Local Area Network (LAN), Wide Area Network (WAN), Metropolitan Area Network (MAN), virtual private network (VPN), storage area network (SAN), frame relay connection, Advanced Intelligent Network (AIN) connection, synchronous optical network (SONET) connection, digital T1, T3, E1 or E3 line, Digital Data Service (DDS) connection, Digital Subscriber Line (DSL) connection, Ethernet connection, Integrated Services Digital Network (ISDN) line, cable modem, Asynchronous Transfer Mode (ATM) connection, or an Fiber Distributed Data Interface (FDDI) or Copper Distributed Data Interface (CDDI) connection. Furthermore, communications network 760 can also include links to any of a variety of wireless networks including Wireless Application Protocol (WAP), General Packet Radio Service (GPRS), Global System for Mobile Communication (GSM), Code Division Multiple Access (CDMA) or Time Division Multiple Access (TDMA), cellular phone networks, Global Positioning System (GPS), cellular digital packet data (CDPD), Research in Motion, Limited (RIM) duplex paging network, Bluetooth radio, or an IEEE 802.11-based radio frequency network.

While the machine-readable medium 750 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, XML, Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, C#, .NET, Adobe Flash, Perl, UNIX Shell, Visual Basic or Visual Basic Script, Virtual Reality Markup Language (VRML), ColdFusion™ or other compilers, assemblers, interpreters, or other computer languages or platforms.

Thus, the technology for remote networked services providing contextual information is disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for providing contextual information regarding available game activities, the method comprising:
maintaining a list of activities associated with at least one application;
receiving information associated with an availability of an activity to a user
determining an estimated playtime for an available activity; and
generating a user interface having contextual information associated with one or more of the available activities, the contextual information including the estimated playtime.

2. The method of claim 1, wherein the determining the estimated playtime for an available activity is based on one or more of statistical information from the completion time of other users, completion time of the user for other activities, user character statistics, user self-identification, and a developer-estimated playtime.

3. The method of claim 1, wherein the user interface includes unified activity modules, each unified activity module having the contextual information corresponding to one of the one or more available activities.

4. The method of claim 3, further comprising determining the one or more of the available activities based on one or more of a proximity to a virtual location of a character of the user, progression towards completion, friend completion, friend activity availability status, friend challenge, the estimated playtime, and a duration in which the activity is available.

5. The method of claim 3, wherein the unified activity modules are arranged in a first order, the first order based on one or more of a proximity to a virtual location of a character of the user, progression towards completion, friend completion, friend activity availability status, friend challenge, the estimated playtime, and a duration in which the activity is available.

6. The method of claim 1, the contextual information further including an activity description, a location, one or more rewards, and a progress.

7. The method of claim 1, further comprising updating the list of activities and the estimated playtime for each available activity in real time.

8. The method of claim 1, wherein the information received from the client further includes, for an in-progress activity, one or more of a start time, an end time, a player roster, context information, outcome information, and a progress amount.

9. The method of claim 1, further comprising, in response to user selection of an activity, transmitting a boot parameter configured to launch the application associated with the activity.

10. A system comprising:
a processor; and
a memory coupled to the processor and storing a program executable by the processor to perform a method for providing contextual information regarding available game activities comprising:
maintaining a list of activities associated with at least one application;
receiving information associated with an availability of an activity to a user;
determining an estimated playtime for an available activity; and
generating a user interface having contextual information associated with one or more of the available activities, the contextual information including the estimated playtime.

11. The system of claim 10, wherein the determining the estimated playtime for an available activity is based on one or more of statistical information from the completion time of other users, completion time of the user for other activities, user character statistics, user self-identification, and a developer-estimated playtime.

12. The system of claim 10, wherein the user interface includes unified activity modules, each unified activity module having the contextual information corresponding to one of the one or more available activities.

13. The system of claim 10, wherein the program is further executable to transmit the generated user interface to a second client.

14. The system of claim 12, wherein the program is further executable to determine the one or more of the available activities based on one or more of a proximity to a virtual location of a character of the user, progression towards completion, friend completion, friend activity availability status, friend challenge, the estimated playtime, and a duration in which the activity is available.

15. The system of claim 12, wherein the unified activity modules are arranged in a first order, the first order based on one or more of a proximity to a virtual location of a character of the user, progression towards completion, friend completion, friend activity availability status, friend challenge, the estimated playtime, and a duration in which the activity is available.

16. The system of claim 10, the contextual information further including an activity description, a location, one or more rewards, and a progress.

17. The system of claim 10, wherein the program is further executable to update the list of activities and the estimated playtime for each available activity in real time.

18. The system of claim 10, wherein the information received from the client further includes, for an in-progress activity, one or more of a start time, an end time, a player roster, context information, outcome information, and a progress amount.

19. The system of claim 10, wherein the program is further executable to, in response to user selection of an activity, transmit a boot parameter configured to launch the application associated with the activity.

20. A non-transitory computer-readable storage medium having embodied thereon a program, the program being executable by a processor to perform a method for providing contextual information regarding available game activities comprising:
maintaining a list of activities associated with at least one application;
receiving information associated with an availability of an activity to a user;
determining an estimated playtime for an available activity; and
generating a user interface having contextual information associated with one or more of the available activities, the contextual information including the estimated playtime.
